(19) United States
(12) Patent Application Publication
(10) Pub. No.: US 2007/0189018 A1
(43) Pub. Date: Aug. 16, 2007

(54) Curing system and method of curing

(75) Inventors: Mark Tausch, West Chester, OH (US); John Howard, Wildwood, MO (US); Thomas Wallenhorst, Liberty Township, OH (US)

Correspondence Address: FOLEY AND LARDNER LLP;SUITE 500, 3000 K STREET NW, WASHINGTON, DC, 20007, US

(73) Assignee: DELAWARE CAPITAL FORMATION, INC.

(21) Appl. No.: 11/505,493

(22) Filed: Aug. 17, 2006

Related U.S. Application Data
(63) Continuation-in-part of application No. 11/355,195, filed on Feb. 16, 2006.

(51) Int. Cl. F21V 7/00

(52) U.S. Cl. 362/346

(57) ABSTRACT

A curing device for curing an ink, varnish, adhesive, and/or adhesive with a lamination film on a web includes a curing housing and a control system. The curing housing includes a xenon light source and an outlet for light emitted by the light source. The control system is configured to calculate a dosage of light applied to the ink, varnish, adhesive, and/or adhesive with a lamination film. The control system is also configured to adjust or maintain the dosage of light applied to the ink, varnish, adhesive, and/or adhesive with a lamination film based on the calculated dosage of light.

### CROSS-REFERENCE TO RELATED APPLICATIONS

This is a continuation-in-part application that claims priority to U.S. patent application Ser. No. 11/355,195, which was filed on Feb. 16, 2006.

### BACKGROUND

The present invention relates to curing printing applications that use, e.g., ultraviolet (“UV”) light or energy for curing. There are numerous sources of curing light or energy including: (a) broadband sources such as: (i) arc lamps constructed with internal electrodes; (ii) arc lamps constructed with internal electrodes and external trigger wires; and (iii) arc lamps constructed without electrodes; (b) narrowband sources such as Excimer lamps; (c) monochromatic sources such as lasers; and (d) electron sources such as electron beam generators.

The transfer of energy from an electron beam into a material is essentially governed by four parameters: (a) the absorbed dosage of energy; (b) the depth to which the electron beam penetrates; (c) the uniformity of the electron beam; and (d) the throughput of the source of electrons. The absorbed dosage is defined as the amount of energy deposited into a specified mass of material. Conventional units for an absorbed dosage of electron beam energy are the kilogray (kGy) and the megarad (Mrad). A kilogray is defined as the number of kilojoules (kJ) of energy deposited into in kilogram (kg) of matter. At a fixed electron acceleration voltage, the dosage is directly proportional to the electron beam current. Typical values of the dosage needed for practical applications include: (a) 15-30 kGy for drying/curing inks and coatings; (b) 25-150 kGy for cross-linking plastic films; and (c) 7.5-35 kGy for sterilization of medical products.

The depth to which the electron beam penetrates is dependent on the acceleration voltage of the electron beam and the density of the processed material—higher voltage increases the depth of penetration whereas higher material density reduces the depth of penetration. For example, a 200 kV beam will experience a 50% dosage at a depth of 0.0090 inches in a material that has a density of 1.0 g/cm³ (e.g., water) and will have the same dosage at half the penetration depth, i.e., at 0.0045 inches, in a material that is twice as dense, i.e., a density of 2.0 g/cm³.

For arc lamps, Excimer lamps, and lasers, the curing dosage is defined as the intensity of the light emitted by the lamp (or laser) from 100 nm to 450 nm multiplied by the duration that an ink, varnish, adhesive, and/or adhesive with a lamination film is exposed to the lamp's (or laser's) light. The conventional units for the intensity are power per area, i.e., Watts per square centimeter (W/cm²) and the conventional units for duration are seconds (s). Thus, for arc lamps, Excimer lamps, and lasers, the units for the curing dosage are (W)(s)/cm², which converts to J/cm².

To be compliant with non-food-contact and with food-contact regulations set forth by the U.S. Food and Drug Administration (“FDA”), a formal qualification process must be followed for each curable ink, varnish, adhesive (e.g., pressure sensitive adhesives (“PSAs”)), and/or adhesive with a lamination film (e.g., to be used instead of over-print varnishes (“OPVs”)). In curable adhesives with lamination films, it is the adhesive (which separates the film from a substrate or “web”) that is cured.

The FDA's qualification process entails: (a) deciding whether a curable ink, varnish, adhesive, and/or adhesive with a lamination film will be used in a non-food-contact application or in a direct food-contact application; (b) deciding what the conditions of use will be for the cured ink, varnish, adhesive, and/or adhesive with a lamination film; (c) choosing a substrate (i.e., web) material to which the curable ink, varnish, adhesive, and/or adhesive with a lamination film will be applied; (d) determining the thickness of the coating of the curable ink, varnish, adhesive, and/or adhesive with a lamination film; (e) curing the curable ink, varnish, adhesive, and/or adhesive with a lamination film; (f) recording the amount of light or energy applied during curing; (g) testing, through migration and/or extraction, the cured ink, varnish, adhesive, and/or adhesive with a lamination film; and (h) comparing the test results with established FDA guidelines for exposure assessment.

If the comparison of the migration/extraction test results to the guidelines are favorable, the singular ink, varnish, adhesive, and/or adhesive with a lamination film may be used as intended and be in compliance with the FDA regulations while taking into account the coat thickness, substrate, and the amount of curing light or energy. Similarly, a combination of ink and varnish may be used, even without a conventional lamination adhesive or lamination film layer, and be in compliance with the FDA regulations while similarly taking into account the coat thickness, substrate, and the amount of curing light or energy. Further, a combination of ink, adhesive, and lamination film may be used, even without a conventional OPV, and be in compliance with the FDA regulations while similarly taking into account the coat thickness, substrate, and the amount of curing light or energy.

As a result of these regulations, the testing that must be undertaken for each ink, varnish, adhesive, and/or adhesive with a lamination film combination, while taking into account the coat thickness and the amount of curing light or energy, is extensive and time consuming. Moreover, even if a chosen protocol satisfies the FDA's regulation, the application of that protocol must be periodically tested to ensure that the system is performing within acceptable ranges. Accordingly, the FDA's regulations present a time- and resource-consuming problem for manufacturers.

In light of the foregoing, it is desired to have a new apparatus and/or method by which the time and resources associated with such testing are reduced.

### SUMMARY

The present invention provides a curing system in which the amount of light or energy radiation is continuously monitored and adjusted (automatically in some embodiments) to remain within a predetermined acceptable range. Such a curing system may be used, for example, in printing presses that are used to apply inks, varnishes, adhesives, and/or adhesives with lamination films to, for example, foodstuffs packaging or other non-foodstuff packaging.

An embodiment of the present invention addresses a curing device for curing an ink, varnish, adhesive, and/or adhesive with a lamination film on a web. This curing device includes, among other possible things, a curing housing and a control system. The curing housing includes, among other possible things: a xenon lamp that is configured to emit light; and an outlet for light emitted by the xenon lamp. The control system is configured to: calculate a dosage of light applied to an ink, varnish, adhesive, and/or adhesive with a lamination film on a web; and adjust or maintain the dosage of light applied to the ink, varnish, adhesive, and/or adhesive with a lamination film on the web based on the calculated dosage of light.

In a further embodiment of this curing device, the xenon lamp may be configured to emit light in response to a pulsed voltage applied to the xenon lamp. Further, the control system may be configured to adjust the dosage of light by adjusting the duration and/or magnitude of the pulsed voltage applied to the xenon lamp.

In another further embodiment of this curing device, the control system may be further configured to: determine a speed of the web passing the outlet; and determine an intensity of the light passing through the outlet. Further, the control system may be configured to calculate the dosage of light based on the speed of the web and the intensity of the light. Additionally or alternatively, the control system may be configured to adjust the dosage of light by adjusting the intensity of the light and/or the speed of the web.

In another further embodiment of this curing device, the control system may include at least one radiometer that is configured to measure the intensity of the light.

In another further embodiment of this curing device, the control system may include at least one speedometer that is configured to measure the speed of the web passing the outlet.

In another further embodiment of this curing device, the control system may include at least one temperature sensor. Further, the at least one temperature sensor may be configured to measure a temperature of the web. Moreover, if the temperature of the web exceeds a predetermined value, the control system may be configured do at least one of the following: (i) activate an alarm; (ii) increase the speed of the web; (iii) decrease the intensity of the light emitted by the housing; (iv) prevent the light from exiting the housing; and/or (v) deactivate the curing housing.

In another further embodiment of this curing device, the curing housing may further include a filter configured to reflect or transmit light that has wavelength(s) that fall within a predetermined wavelength range toward the outlet. Further, the filter may be configured to let UV light pass therethrough.

In another further embodiment of this curing device, the device may additionally include an alarm that is configured to alert a technician if the calculated dosage of light differs from a predetermined dosage or is outside a predetermined dosage range.

In another further embodiment of this curing device, the predetermined dosage and predetermined dosage range may be based on the type and thickness of the ink, varnish, adhesive, and/or adhesive with a lamination film applied to the web.

In another further embodiment of this curing device, the device may additionally include a heat sink. Further, the web may be positioned between the curing housing outlet and the heat sink.

Another embodiment of the present invention addresses a curing device for curing an ink, varnish, adhesive, and/or adhesive with a lamination film on a web. This curing device includes, among other possible things: (a) a curing housing that includes, among other possible things: (i) a xenon lamp that is configured to emit light; and (ii) an outlet for light emitted by the light source; (b) means for calculating a dosage of light applied to an ink, varnish, adhesive, and/or adhesive with a lamination film on a web via the outlet; and (c) means for adjusting or maintaining the dosage of light applied to the ink, varnish, adhesive, and/or adhesive with a lamination film on the web based on the calculated dosage of light.

In a further embodiment of this curing device, the xenon lamp may be configured to emit light in response to a pulsed voltage applied to the xenon lamp. Further, the means for adjusting or maintaining the dosage of light may be configured to adjust the dosage of light by adjusting the duration and/or magnitude of the pulsed voltage applied to the xenon lamp.

In another further embodiment of this curing device, the device may additionally include: means for determining a speed of the web passing the outlet; and means for determining an intensity of the light passing through the outlet. Further, the means for calculating a dosage of light applied to the web may be configured to calculate the dosage of light based on the speed of the web and the intensity of the light. Additionally or alternatively, the means for determining the speed of a web passing the outlet may include at least one speedometer

In another further embodiment of this curing device, the means for adjusting the dosage of light may be configured to adjust the dosage of light by adjusting the intensity of the light and/or the speed of the web.

In another further embodiment of this curing device, the device may additionally include: at least one temperature sensor configured to measure a temperature of the web; and control means. Further, if the temperature of the web exceeds a predetermined value, the control means may be configured to do at least one of the following: (i) activate an alarm; (ii) increase the speed of the web; (iii) decrease the intensity of the light emitted by the housing; (iv) prevent the light from exiting the housing; and/or (v) deactivate the curing housing.

In another further embodiment of this curing device, the means for determining the intensity of the light passing through the outlet may include at least one radiometer. Further, at least one of the radiometers may be aligned with the outlet at a position in which the web is not configured to pass between the radiometer and the lamp.

In another further embodiment of this curing device, the device may additionally include a temperature sensor configured to monitor a temperature of the web passing the outlet.

In another further embodiment of this curing device, the curing housing may additionally include a filter configured to reflect or transmit light that has wavelength(s) that fall within a predetermined wavelength range toward the outlet. Further, the filter may be configured to enable UV light to pass therethrough.

In another further embodiment of this curing device, the device may additionally include an alarm that is configured to alert a technician if the calculated dosage of light differs from a predetermined dosage or is outside a predetermined dosage range. Further, the predetermined dosage and predetermined dosage range may be based on the type and thickness of the ink, varnish, adhesive, and/or adhesive with a lamination film applied to the web.

In another further embodiment of this curing device, the device may additionally include a heat sink. Further, the web may be positioned between the curing housing outlet and the heat sink.

Another embodiment of the present invention addresses a method that includes, among other possible steps: (A) emitting light using a curing housing; (B) determining a dosage of the light emitted by the curing housing; (C) comparing the determined dosage of light to a predetermined dosage or predetermined dosage range; and (D) performing one of the following steps (i) and (ii): (i) if the determined dosage of light is compared in step (C) to a predetermined dosage, performing one of the following steps (a) and (b): (a) adjusting an intensity of the light emitted by the curing housing and/or a speed of a web on which an ink, varnish, adhesive, and/or adhesive with a lamination film will be provided if the determined dosage of light differs from the predetermined dosage; or (b) maintaining the speed of the web and the intensity of the light emitted by the curing housing, if the determined dosage of light is substantially the same as the predetermined dosage; or (ii) if the determined dosage of light is compared in step (C) to a predetermined dosage range, performing one of the following steps (c) and (d): (c) adjusting the intensity of the light emitted by the curing housing and/or the speed of the web if the determined dosage of light is outside the predetermined dosage range; or (d) maintaining the speed of the web and the intensity of the light emitted by the curing housing, if the determined dosage of light is within the predetermined dosage range.

In a further embodiment of this method, the method may further includes the step of: (E) cyclically repeating steps (B)-(D). Moreover, the steps (B), (C), and (D) may be initially performed by a technician located at the curing housing and may be subsequently performed by a controller that is electrically connected to the curing housing. Further, the controller may be electrically connected to the curing housing via an internet connection.

In another embodiment of this method, the method may further include the steps of: determining an intensity of the light emitted by the curing housing using one or more radiometers; and determining the speed at which the web is moving relative to the curing housing. Further, the step of (B) determining a dosage of the light emitted by the curing housing may use the determined intensity of the light emitted by the curing housing and the determined speed at which the web is moving.

In another embodiment of this method, before the step of (A) emitting light using a curing housing, the method may further include the steps of: (A1) emitting light using a calibrated light source; and (A2) determining an intensity of the light emitted by the calibrated light source using one or more radiometers. Further, the method may further include the steps of: (A3) ascertaining whether any of the radiometers is malfunctioning by comparing the intensity of the light emitted by the calibrated light source as determined by each of the radiometers to a predetermined, calibrated light intensity or to a predetermined, calibrated light intensity range; (A4) if any of the radiometers is ascertained to be malfunctioning, either: (i) removing the malfunctioning radiometer(s); or (ii) replacing the malfunctioning radiometer(s) and repeating steps (A2) and (A3); and (A5) eliminating the light emitted by the calibrated light source. Further, the step of (A)(1) emitting light using a calibrated light source may include the step of: positioning the calibrated light source in a predetermined location relative to the curing housing and/or the one or more radiometers.

In another embodiment of this method, the steps of (D)(i)(a) and/or (D)(ii)(c) adjusting the intensity of the light emitted by the curing housing, may include the step of: eliminating the light emitted by the curing housing.

In another embodiment of this method, the steps of (D)(i)(a) and/or (D)(ii)(c) adjusting the speed of the web, may include the step of: stopping the web.

In a further embodiment of this method, before the step of (A) emitting light using a curing housing, the method may further include the step of: ascertaining the predetermined dosage or predetermined dosage range. Further, the step of ascertaining the predetermined dosage or predetermined dosage range may include one or more of the following steps: scanning a barcode and obtaining from a lookup table dosage information corresponding to the barcode; reading information stored on a radio frequency identification chip; and/or receiving dosage information from a remote location.

These and other features, aspects, and advantages of the present invention will become more apparent from the following description, appended claims, and accompanying exemplary embodiments shown in the drawings.

### BRIEF DESCRIPTION OF THE DRAWINGS

The accompanying drawings, which are incorporated in and constitute a part of the specification, illustrate embodiments of the invention and together with the description, serve to explain the principles of the invention.

FIG. 1 is a schematic view of a conventional cold mirror UV curing lamp housing;

FIG. 2 is a schematic view of the conventional cold mirror UV curing lamp housing of FIG. 1 illustrating how some of the light generated by a light source is reflected by a band-pass filter so as to leave the housing via a window, whereas other light generated by the light source passes through the band pass filter and into a heat sink;

FIG. 3 is a schematic view of a conventional hot mirror UV curing lamp housing in which some of the light generated by a light source is transmitted through a band-pass filter so as to leave the housing via a window, whereas other light generated by the light source is reflected by the band pass filter;

FIG. 4 is a schematic view of a cold mirror UV curing lamp housing of the type shown in FIGS. 1 and 2 but additionally including a second heat sink behind the web;

FIG. 5 is a schematic view of a hot mirror UV curing lamp housing of the type shown in FIG. 3 but additionally including a heat sink behind the web;

FIG. 6 is a schematic view of an electron beam curing housing;

FIG. 7 is a break-away, perspective view of the window outlet of a UV curing lamp housing such as one of the types shown in FIGS. 1, 2, and 4 and a web passing thereby, the view showing that the length of the light source is greater than the width of the web;

FIG. 8 is a schematic view of a curing device that includes a curing housing such as one of the types shown in FIGS. 1-6 and a control system; and

FIG. 9 is a block diagram that depicts an embodiment of a control method according to the present invention.

### DETAILED DESCRIPTION

Reference will now be made in detail to embodiments of the invention, which are illustrated in the drawings. An effort has been made to use the same reference numbers throughout the drawings to refer to the same or like parts.

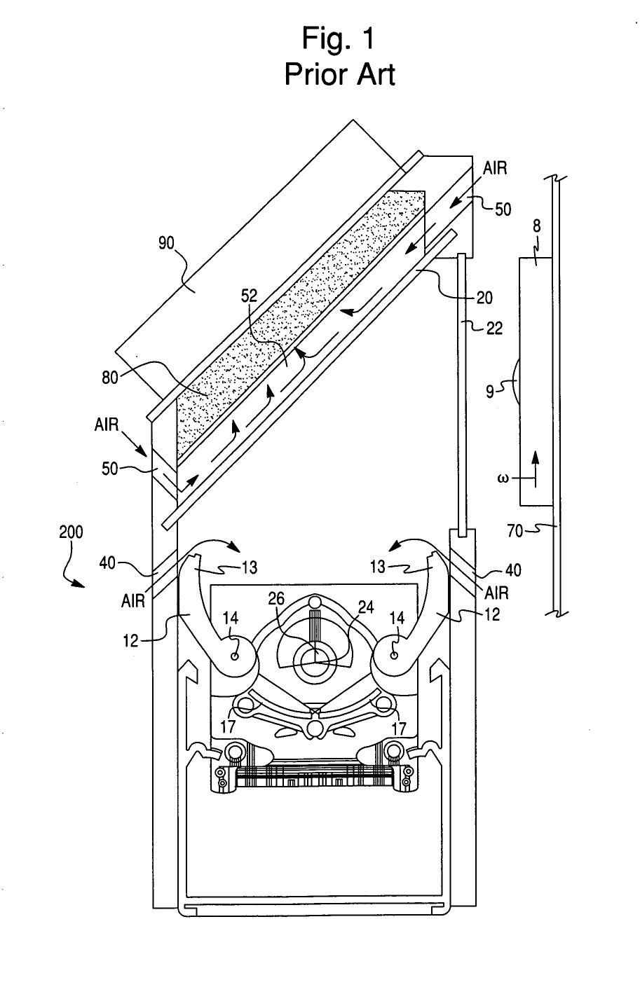

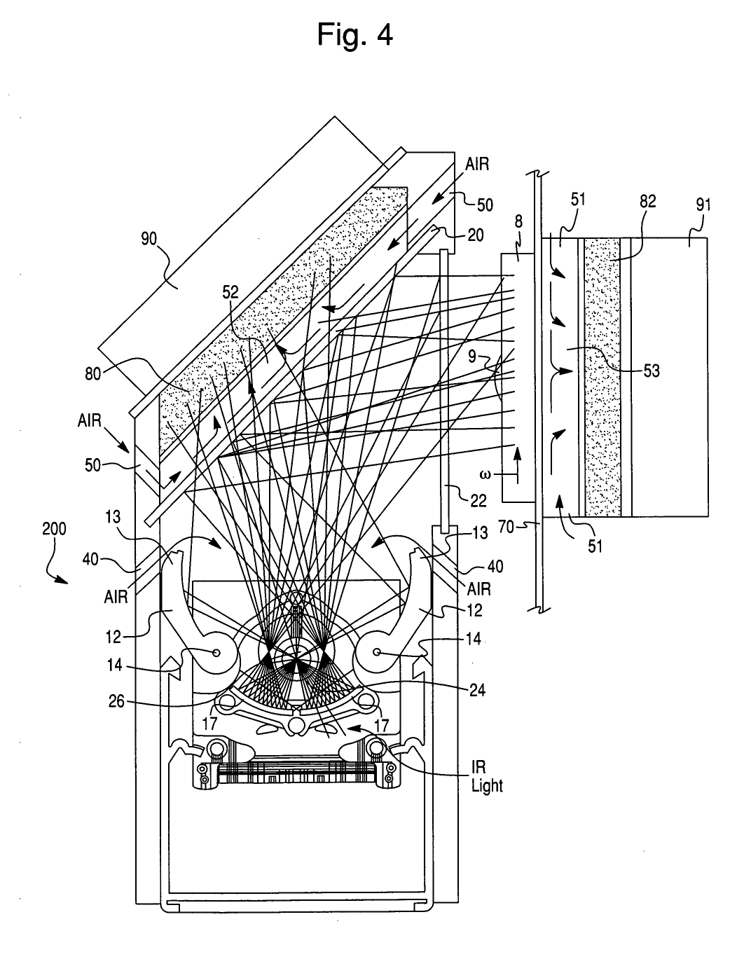

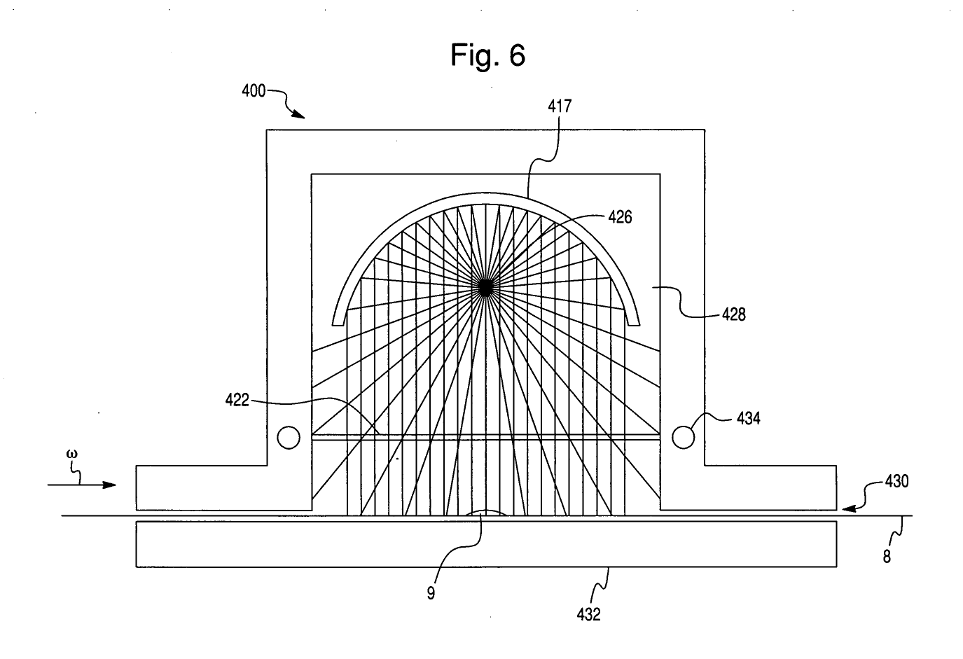

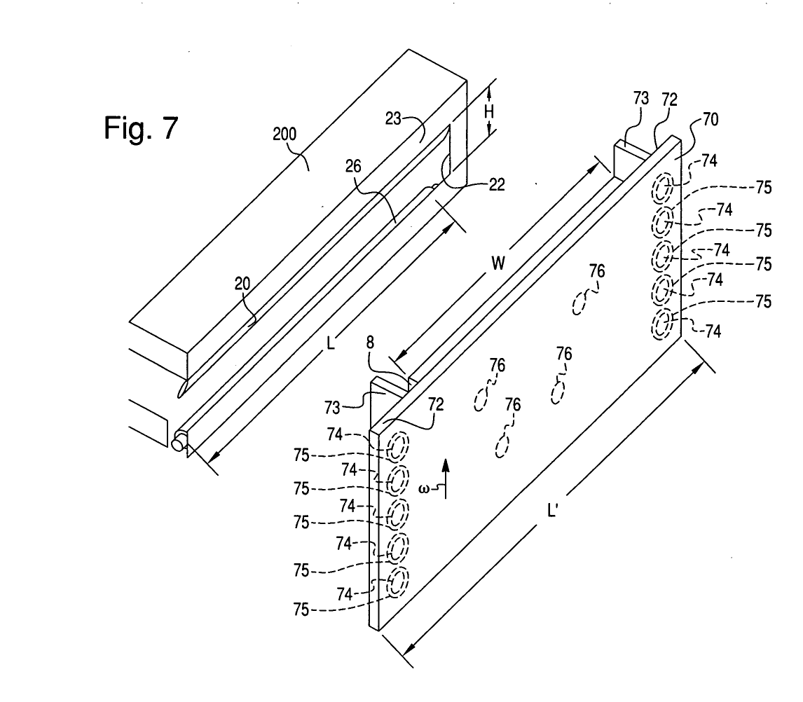

The curing device embodiments hereafter described involve a curing housing interfaced with a control system and possibly with a heat sink. UV arc lamp housings 200, 300 will be described with respect to FIGS. 1-5, an electron beam curing housing 400 will be described with respect to FIG. 6. Thereafter, the control system 100 will be described with respect to FIGS. 7-9.

With respect to the embodiments of FIGS. 1-5, the purpose of reflective surfaces in a UV curing lamp housing 200, 300 is to gather and direct light emitted from a light source (also referred to as a “lamp”) 26 to a substrate (hereafter referred to as a “web”) 8 where UV curing will take place. Some reflective and transmissive surfaces discussed in detail herein are, in actuality, band-pass filters. These band-pass filters transmit certain wavelengths of light and reflect other wavelengths of light. Other reflective surfaces, referred to as “reflectors” reflect substantially all light incident thereon.

The light source 26 may be, for example, an arc lamp (e.g., a pulsed xenon arc lamp that provides hot restart and instant on/off capabilities), an Excimer lamp, a laser, or other light source. Further, the light emitted from the light source 26 may be composed of, for example, three main regions of the electromagnetic spectrum: (a) wavelengths from about 200 nm to about 400 nm are generally considered to fall within the UV portion of the spectrum; (b) wavelengths from about 400 nm to about 760 nm are generally consider to fall within the visible part of the spectrum; and (c) wavelengths from about 760 nm to about 3,000 nm are generally considered to fall within the near infrared (“IR”) portion of the spectrum.

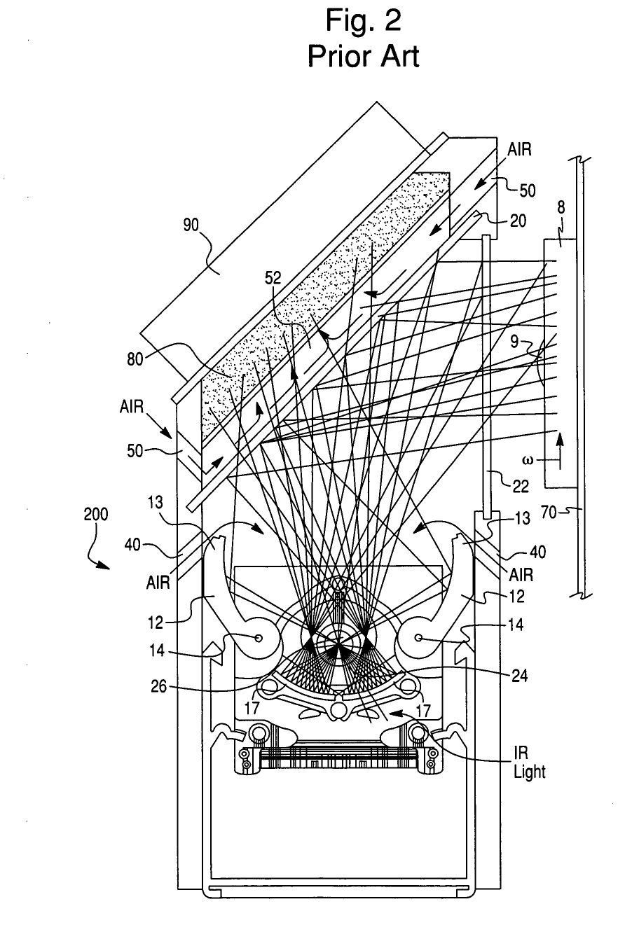

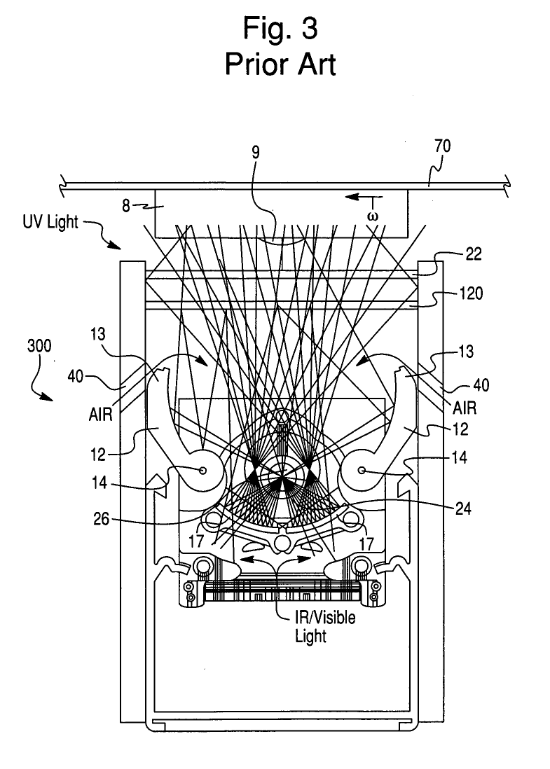

In the housings 200, 300, the light emitted by the light source 26 may be reflected by a curved, two-part mirror 17, as shown in FIGS. 2 and 3. The two-part, mirror 17 may be fabricated from metallic or nonmetallic materials that may be, for example, extruded, machined, formed, cast, drawn, or molded. In addition, the mirror 17 may be created from a substrate material that is subjected to any number of finishing methods including, but not limited to, polishing, coating, and plating. Further, the shape of each of the parts of the two-part, mirror 17 can be, but is not limited to, spherical, cylindrical, aspheric, and a series of flats (i.e., a series of short planar surfaces joined together to form a curved surface).

The curved surfaces of the mirror 17 may be designed using a method called “optical ray tracing” that is performed using computer aided design (“CAD”), which traces each light ray. This method describes reflection and refraction of light when the light contacts a material such as an optical surface. Further, the ray tracing may be done automatically using optical design software programs. In addition, one or both of the parts of the two-part mirror 17 may be a reflector or a band-pass filter. For example, either or both of the parts of the mirror 17 may be a cold mirror such as that of a type later described.

After the light is redirected in a second direction by the mirror 17, it joins other light that originated in that second direction from the lamp 26; this combination of light must be separated into useable and unusable wavelengths. One way to separate the light is by using an optical filter such as a band-pass filter 20, 120. For example, a band-pass filter 20, 120 may separate UV light from other types of light (e.g., IR and visible light) so that the UV light can be used in applications that depend on UV light (and that may be hampered by other types of light), such as UV curing applications. Thus, the purpose of a band-pass filter is to reflect (or transmit) light in a specific range of wavelengths and to transmit (or reflect) light of a different set of wavelengths.

A particular type of band-pass filter, often referred to as a “cold mirror” 20, may be used to provide good reflection of light having wavelengths in a particular range and to transmit light outside of that range. For example, one type of cold mirror reflects light having wavelengths between about 200 nm and about 450 nm (i.e., UV light and the lower end of the visible light spectrum) and transmits light having wavelengths above about 450 nm, i.e., light that includes most visible light and IR light. The UV light may be reflected by the cold mirror through protective window 22 (also referred to as an “outlet”) and toward a web 8 that is to be UV cured. By way of contrast, the visible/IR light may be transmitted through the cold mirror (i.e., it is not directed toward the web 8), to prevent unnecessary and unwanted heating of the web 8 that is to be cured.

Another type of band pass filter, which acts essentially opposite from a cold mirror, is a “hot mirror” 120. A hot mirror is a type of band-pass filter that generally reflects light having wavelengths from about 400 nm to about 3,000 nm (i.e., visible and IR light) and transmits light having wavelengths from about 200 nm to about 400 nm (i.e., UV light). In other words, whereas cold mirrors generally transmit IR and visible light and reflect UV light, hot mirrors do substantially the opposite, i.e., they generally reflect IR and visible light and transmit UV light.

Optical coatings that are transparent to particular wavelengths of light may be used in conjunction with the band-pass filters 20, 120. In one embodiment, optical coatings, which reflect specific wavelength photonic energy that have angles of incidence from about 0° to about 45° (and greater), may be employed. Additionally, the optical coatings may be used to transmit different specific wavelength photonic energy having angles of incidence from about 0° to about 45° (and greater).

The band-pass filters 20, 120 may be fabricated from nonmetallic materials that are, for example, extruded, machined, formed, cast, drawn, or molded. Further, the band-pass filters 20, 120 may be created from a substrate material that is subjected to any number of finishing methods including, but not limited to, polishing, coating, plating, and electroplating. For example, the band-pass filters 20, 120 may be coated and polished. In addition, the shape of the band-pass filters 20, 120 may be, for example, cylindrical, aspheric, flat, or a series of flats.

As shown in the embodiment of FIGS. 1, 2, and 4, the curing lamp housing 200 contains the lamp 26 (also called a “light source 26”) that projects diverging light that has a variety of wavelengths from the interior 24 of the lamp 26. An embodiment of such a lamp may include an externally triggered pulsed xenon lamp that provides hot restart and instant on/off capabilities. Some of the light is directed toward the reflective mirror 17, which reflects at least some (e.g., UV) of the light toward a band-pass filter 20; the remainder (e.g., IR/visible) of the light may pass through the mirror 17.

The band-pass filter 20 may be a cold mirror. Further, it may also be a folding mirror i.e., an optical device used to change the direction of light rays. This band-pass filter 20 could be used to redirect a portion of the light (e.g., the UV light) to a two- or three-dimensional plane or web 8 at which, for example, UV curing is to take place. If the band-pass filter 20 were planar (as shown in FIGS. 1, 2, and 4), the angle of the band-pass filter 20 with respect to the long axis of the lamp could be, for example, about 45°. However, there is no requirement that the band-pass filter 20 be planar in shape or at any particular angle. Rather, as previously mentioned, the shape of the reflective surface of the band-pass filter 20 may be, but is not limited to, spherical, cylindrical, aspheric, a series of flats, for example.

As the remaining light (e.g. visible/IR) is transmitted through the band-pass filter 20, it may be necessary to protect people and/or items that may be harmed by exposure to this light. To address this concern, the (e.g., visible/IR) light transmitted through the band-pass filter 20 may pass through an air corridor 52 and into a heat sink 80 where it may be absorbed and converted into heat energy via radiant heat transfer.

The heat sink 80 may be formed of a woolen material comprising a random array of fibers some of which may be curved and twisted around each other. Moreover, the heat sink 80 may be formed of a metal wool such as, for example, carbon steel wool, aluminum wool, bronze wool, or stainless steel wool. Each of these metal wool types is available from International Steel Wool/BonnCo Abrasives, P.O. Box 2237, Mission, Tex. 78537. In addition, wool materials that have high coefficients of thermal conductivity and low reflectivity values in a desired wavelength range may be used.

Air, which is fed into the air corridor 52 via inlets 50, is used to cool the heat sink 80. In addition, the cooling of the heat sink 80 can be further aided by using a fan 90 such as, for example, a muffin fan, pressure blower, volume blower, cage blower, compressed air, natural convection fan, or other appropriate fan design. In one embodiment, the fan 90 is positioned on the side of the heat sink 80 opposite the air corridor 52 such that the fan 90 serves to pull air from the air corridor 52 through the heat sink 80. In addition, air (which may be fed into the housing 200 via inlets 40) may be used to cool the light source 26, the shutters 12, and/or the curved reflective mirror 17.

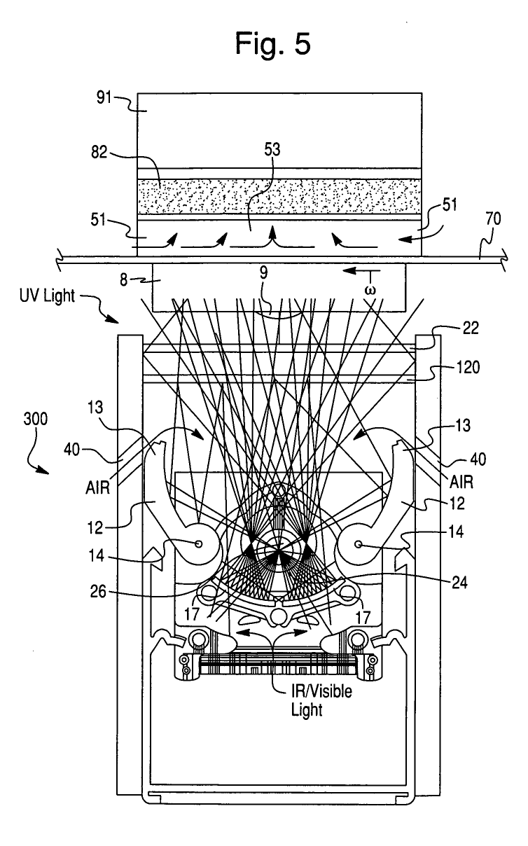

As shown in the hot mirror embodiment of FIGS. 3 and 5, the curing lamp housing 300 also contains a lamp 26 that projects diverging light that has a variety of wavelengths from the interior 24 of the lamp 26. An embodiment of such a lamp may include an externally triggered pulsed xenon lamp that provides hot restart and instant on/off capabilities. Some of the light is directed toward the reflective mirror 17, which reflects at least some (e.g., UV) of the light toward a band-pass filter 120; the remainder (e.g., IR/visible) of the light may pass through the mirror 17.

The band-pass filter 120 may be a hot mirror. Further, it may also be a folding mirror. This band-pass filter 120 could be used to transmit a portion of the light (e.g., the UV light) to a two- or three-dimensional plane or web 8 at which, for example, UV curing is to take place. If the band-pass filter 120 were planar (as shown in FIGS. 3 and 5), the angle of the band-pass filter 120 with respect to the long axis of the lamp could be, for example, about 0°. However, there is no requirement that the band-pass filter 120 be planar in shape or at any particular angle. Rather, as previously mentioned, the shape of the reflective surface of the band-pass filter 120 may be, but is not limited to, spherical, cylindrical, aspheric, a series of flats, for example.

As the remaining light (e.g. visible/IR) is reflected by the band-pass filter 120, it may be unnecessary to protect people and/or items that may be harmed by exposure to this light. Accordingly, unlike the previous embodiment, a heat sink 80 may be omitted. However, similar to the previous embodiment, air (which may be fed into the housing 300 via inlets 40) may be used to cool the light source 26, the shutters 12, and/or the curved reflective mirror 17.

In both of the aforementioned housings 200, 300, some of the light from the light source 26 is also reflected off the shutters 12 toward the band-pass filter 20, 120. The shutters 12, which rotate on axes 14, have inside surfaces (i.e., on the side facing the light source) that are highly polished. As a result, when an object or web 8 (which may be in the form of a tape or label) to be cured is moved in a direction Co past the window outlet 22 in the housing 200, 300, the shutters 12 may be opened and the polished surface of the shutters 12 used to gather and direct the light toward the band-pass filter 20, 120.

The shutters 12 may be opened due to their being adapted to rotate on the axes 14. In a first, closed position (not shown), the distal ends 13 of the shutters 12 approach each other, thereby substantially containing the light emitted by light source 26. In a second, open position, which is shown in FIGS. 1-5, the distal ends 13 of the shutters 12 are separated so that the light emitted by the light source 26 can be reflected toward the band-pass filter 20, 120.

The shutters 12 also serve a heat containment function. The temperature of the light source 26 may reach, for example, about 650° C. to about 850° C. In some embodiments, as the light source 26 is reasonably close to the moving web 8, if the web 8 is stopped while the housing 200, 300 is emitting light, it may be preferable to protect the web 8 from the heat associated with the light emitted by light source 26 by closing the shutters 12.

In operation, the shutters 12 will be moved to the open position in which the distal ends 13 of the shutters are away from each other (as shown in FIGS. 1-5). The light source 26 will be activated to radiate light energy. Some of the light will reflect off of the curved two-part mirror 17 and off of the shutters 12 toward the band-pass filter 20, 120, whereas some of the light will travel directly from the light source 26 to the band-pass filter 20, 120. Light having wavelengths in a specified range (e.g., about 200 nm to about 450 nm) will be reflected by the cold mirror band-pass filter 20 or transmitted by the hot mirror band-pass filter 120; in both cases, the reflected/transmitted light is projected through the protective window 22. If a cold mirror band pass filter 20 is provided, the remainder of the light (i.e., light having wavelengths that do not fall within the specified range) will be transmitted through the cold mirror band-pass filter 20 and the air corridor 50 and into the heat sink 80 in which the light energy will be converted into heat energy; the heat energy will be dissipated by the influx of air in the air corridor 52 and by a fan 90, if one is provided. If a hot mirror band-pass filter is provided, the remainder of the light (i.e., light having wavelengths that do not fall within the specified range) will be reflected by the hot mirror band-pass filter 120.

The UV light that is reflected by the cold mirror band-pass filter 20 or transmitted through the hot mirror band-pass filter 120 passes through the protective window 22. The protective window 22 is preferably made of materials that transmit UV light and may be positioned proximate to the band-pass filter 20, 120 without being in contact therewith.

The protective window 22 may be fabricated from nonmetallic materials that are, for example, extruded, machined, formed, cast, drawn, or molded. Further, the protective window 22 may be created from a substrate material that is subjected to any number of finishing methods including, but not limited to, polishing, coating, plating, electroplating. In addition, the shape of the protective window 22 may be, for example, cylindrical, aspheric, flat, or a series of flats.

The UV light that passes through the window 22 will be incident on the web 8 moving past the window 22. The UV light may, for example, be used to cure an ink, varnish, adhesive, and/or adhesive with a lamination film 9 on the surface of the web 8. After passing through the web 8, the UV light may, for example, be absorbed by a heat sink 82 positioned behind the web 8, as shown in FIGS. 3 and 5. This heat sink 82, like the heat sink 80 previously described with reference to FIGS. 1, 2 and 4, may be provided with a cooling fan 91 as well as an air corridor 53 that has inlets 51.

In contrast to the non-ionizing UV light emitted by the cold mirror and hot mirror housings 200, 300 (as well as laser containing housings), other embodiments of the present invention contemplate ionizing energy such as electron beams. The embodiment shown in FIG. 6 depicts an electron beam curing housing 400 that will hereafter be discussed.

As shown in FIG. 6, in one embodiment electrons are generated when high voltage is applied to an electron source (e.g., tungsten wire filament) 426 inside a vacuum chamber 428. The vacuum in the chamber 428 must be such that the filament 426 is not incinerated. For example, the vacuum may be about 10⁻⁵ to about 10⁻⁶ Torr. The electron source 426 is heated electrically such that it glows white hot and generates a cloud of electrons. These electrons are then directed, in part by a curved repeller plate 417, and drawn from the cloud to areas of lesser voltage. The electrons are then accelerated and focused to very high speeds of, for example, more than a 100,000 miles per second, i.e., about 54% the speed of light. The electrons, which exit the vacuum chamber 428 through a titanium foil window outlet 422, then fall upon the web 8 that is to be cured.

To provide as little interference as possible, the titanium foil window outlet 422 has a thickness of, for example, about 15 μm. In addition, to minimize heating of the window 422 caused by the impact and transmission of electrons, cooling water 434 may be dispersed on the window 422; treated (e.g., deionized) cooling water is preferable as it leaves fewer deposits.

Nitrogen inerting gas, which is indicated by reference character 430, is provided between the titanium window 422 and the surface of the web 8. The nitrogen gas serves to prevent oxygen inhibition by an ink, varnish and/or adhesive on the web. Oxygen inhibition is a situation in which oxygen molecules at or near the surface of the uncured ink, varnish, and/or adhesive are chemically motivated to join with atmospheric oxygen molecules, and thereby escape from the uncured ink, varnish, and/or adhesive. The escape of such oxygen molecules prohibits (or at least greatly inhibits) the surface cure of the ink, varnish, and/or adhesive. It should be recognized that adhesives with a lamination film do not encounter oxygen inhibition because the lamination film traps the oxygen molecules at the surface of the adhesive.

When electrons collide with any gas molecule they generate X-rays, which constitute ionizing radiation, i.e., the X-rays have the negative ability to disrupt cells at a molecular level. Accordingly, when the electrons collide with the inerting nitrogen gas, the generation of X-rays is possible. To reduce potentially harmful effects of such X-rays, a protective shield 432 such as, for example, a one quarter inch thick sheet of stainless steel or a one inch thick sheet of lead, may be provided around substantially the entire curing area, as shown.

According to one embodiment of the present invention, the previously described curing housings 200, 300, 400 may be coupled to a control system 100 so that a dosage of light emanating from a UV curing lamp housing 200, 300 or the dosage of energy emanating from an electron beam curing housing 400 may be controlled. Moreover, in some embodiments the control may be automatic via real-time feedback. The interconnection between the curing housings 200, 300, 400 and the control system 100 will hereafter be described with reference to FIGS. 7-9. Although only the cold mirror curing lamp housing 200 is shown in FIG. 7, it is to be understood that the hot mirror curing lamp housing 300 and the electron beam curing housing 400 (as well as other curing housings such as laser housings) also could be used in a similar fashion and, therefore, a duplicative discussion thereof is omitted.

As shown in FIG. 7 (which has the shutters 12 and the second heat sink 82 removed for ease of viewing), the web 8 may be transported past the window 22 by a transport device 70. In use, the web 8 is sandwiched generally either between the transport device 70 and a face 23 (which includes the window 22) of the curing housing 200, 300, 400 or between a web tunnel (not shown) that extends from, and has the same width H as, the window 22 of the curing housing 200, 300, 400.

The transport device 70 may be, for example, a conveyor belt or may simply involve a series of rollers that serve to direct the web 8 past the housing 200, 300, 400. The transport device 70 has a width L′ that is at least as great as a length L of the arc lamp 26 or electron source 426 and/or the length of the window 22, 422. In contrast, the width W of the web 8 is less than the length L′ of the transport device 70 and the length L of the arc lamp 26 or electron source 426 and/or their windows 22, 422. As a result, margins 72 on the transport device 70 are provided along both sides of the web 8.

As shown in hidden lines, one or more sensors 74 are provided along the margins 72 of the transport device 70. The sensors 74 can monitor the intensity of the light or energy (which emanates from the curing housing 200, 300, 400) that is incident on the margins 72 (i.e., not impeded by the web 8). The sensors 74 may either be provided, for example, on an outer surface of the transport device 70 or within the transport device 70, provided they may remain stationary with respect to the curing housing 200, 300, 400 while the transport device 70 is transporting the web 8. In other embodiments, the sensors 74 may be provided on the web 8 such that they move past the housing 200, 300, 400 with the web 8. Finally, as later explained in detail, in some embodiments, the sensors 74 may be provided on a test stand that is separate from the transport device 70 and the web 8; in such instances the test stand is periodically used to test the intensity of the light/energy of the housing 200, 300, 400 before the web 8 is exposed thereto.

The sensors 74 may be, for example, radiometers (or other photosensitive sensors) or electron beam detectors. The sensors 74 serve to measure (continuously or periodically) an intensity of the light or energy emanating from the curing housing 200, 300, 400 and to output signals reflective of the measured intensity. Moreover, each of the sensors 74 may provide real-time data regarding the intensity of the light or energy measured thereby.

One sensor that may be used for light curing applications is the “UV PowerMAP” (and its corresponding PowerView application software) manufactured by Electronic Instrumentation and Technology, Inc. The PowerMAP measures and records the intensity of the three types of UV radiation, i.e., UVA radiation (which comprises wavelengths of 315 nm to 400 nm), UVB radiation (which comprises wavelengths of 280 nm to 315 nm), and UVC radiation (which comprises wavelengths of 200 to 280 nm). Of the three types of UV light, wavelengths of about 250 nm to about 260 nm (i.e., light in the UVC range) may be particularly suitable for certain UV curing applications and may be readily detected by the PowerMAP's UVC detector.

Before the PowerMAP sensors are used, each of the sensors 74 should be tested by a technician located at the curing housing 200, 300. For example, each of the sensors 74 could be positioned at a predetermined location as shown in FIG. 7. To protect the sensors 74, the margins 72 may be insulated from the web 8 by means of barrier walls 73. The barrier walls 73 may provide a physical barrier that may prevent ink misting (from the curing ink, varnish, adhesive, or adhesive with a lamination film provided on the web) and/or paper dust (from the web 8 itself) from accumulating on, and reducing the sensitivity of, the sensors 74. The barrier walls 73 may also insulate one or more calibrated light sources 75, which may be provided at predetermined locations on the margins 72, from the web 8. The locations of the calibrated light sources 75 are predetermined so that the accuracy of intensity readings, as measured by the sensors 74, can be consistently verified by a technician who initially configures and tests the curing lamp housings 200, 300. Moreover, as shown, the locations of the calibrated light sources 75 may be substantially adjacent the sensors 74 so that the accuracy of the intensity measurements taken by the sensors 74 can be enhanced.

The calibrated light source(s) 75 (the output intensity of which is known) could be positioned directly adjacent each of the sensors 74. The light intensity measurements taken by the sensors 74 can be compared by the technician to the known intensity value. If any of the sensors 74 are malfunctioning (or reflect improper calibration), the sensors 74 may be, either removed or replaced by the technician. If one or more malfunctioning sensors are replaced, the technician would then, of course, compare the intensity reading of the replacement sensor(s) to the known intensity value to confirm that the replacement sensor(s) are properly functioning. After the integrity of each of the sensors is confirmed, the technician can obtain a desired dosage (as later described in detail). By adjusting the intensity of the light being emitted by the curing lamp housing 200, 300 and/or the web speed, the technician can obtain the desired dosage. Once the desired dosage output is confirmed by the technician, the curing process can begin. Moreover, the curing process can subsequently be remotely monitored and controlled (as later described in detail).

Due to the thickness and cost of the PowerMAP sensor, it may in some embodiments, be preferable to use the PowerMAP sensor to test the intensity of the curing housing 200, 300 separately from the web 8 and/or transport device 70. In such embodiments, the PowerMAP sensors can be placed on a tray of a test device that is moved past the window 22 of the curing housing 200, 300 at a speed (e.g., 25 feet per minute) that may be slower than the speed at which the web will travel (e.g., 300 feet per minute). In so doing, the tray is moved past the window 22 such that the distance between the window 22 and the photosensitive surface of PowerMAP sensor will be substantially equal to the distance between the web 8 and the window, when the web 8 is employed. In moving the PowerMAP sensor past the window, the sensor could pass the window at a position that would align with the margin 72 of the transport device 70 (when employed) or the web 8 (when employed).

The PowerMAP sensor is designed such that it can have a minimum light intensity threshold that it must detect before it starts to record data. Accordingly, the sensor can be designed to travel with the test stand such that when the sensor is aligned with the window 22 of the housing 200, 300, the light intensity will be such that the sensor will start measuring and recording data. And, when the sensor passes the window 22, the sensor will stop measuring and recording data due to the intensity level falling below the minimum threshold.

The frequency at which the PowerMAP sensor measures and records the intensity of the light is variable. Specifically, the PowerMAP has a sampling rate (i.e., the number of samples per given unit of time) that can be adjusted from 128 samples per second to 2,048 samples per second. The sampling rate of the PowerMAP sensor may be used to ascertain a more accurate reading of the light intensity. For example, over the width H of the window 22, the intensity likely varies. Accordingly, if only one stationary sensor 74 were employed, a reading of the light intensity of the housing 200, 300 may be, on the whole, too low or too high; this inaccurate intensity measurement would lead (as later explained in detail) to inaccurate light dosage calculations. In contrast, the sampling rate of the PowerMAP sensor enables many intensity readings (for each of UVA, UVB, and/or UVC radiation) to be taken across the width H of the window 22. The PowerMAP sensor may then normalize the data to define more accurately the intensity to which the web 8 will be exposed.

Regardless of the number of samples taken, after a sampling run is complete, the PowerMAP sensor is connected, electrically (wired) or wirelessly, to the computer 102. The computer 102 then downloads the intensity data, which may, as previously discussed, be normalized, recorded in the PowerMAP radiometer. The computer 102 may also download, in the case of the PowerMAP sensor, peak light intensities (mW/cm²) for the width H of the window 22 such that potential “hot spots” may be identified, which may be indicative of a problem with the light source 26. Further, in some embodiments, the (normalized) light intensity levels measured by the PowerMAP can be converted by the sensors themselves to a curing dosage, which is then uploaded by the computer 102. Note that in other embodiments, the sensor 74 may be configured to provide a continuous or periodic feed of data to the computer 102.

For UV curing lamp housings 200, 300, in one embodiment the dosage determinations are based on the exposure time multiplied by the light intensity measured by the sensor. For sensors such as the PowerMAP that take multiple intensity readings during the sampling window (i.e., the time from when the sensor is activated due to the intensity of the light being above the threshold to the time when the sensor is deactivated due to the intensity of the light falling below the threshold), the dosage would be determined based on the exposure time multiplied by the normalized light intensity. From this light dosage and intensity data, the light dosage for other web speeds and/or light intensities can be extrapolated in the computer 102, as later explained in detail.

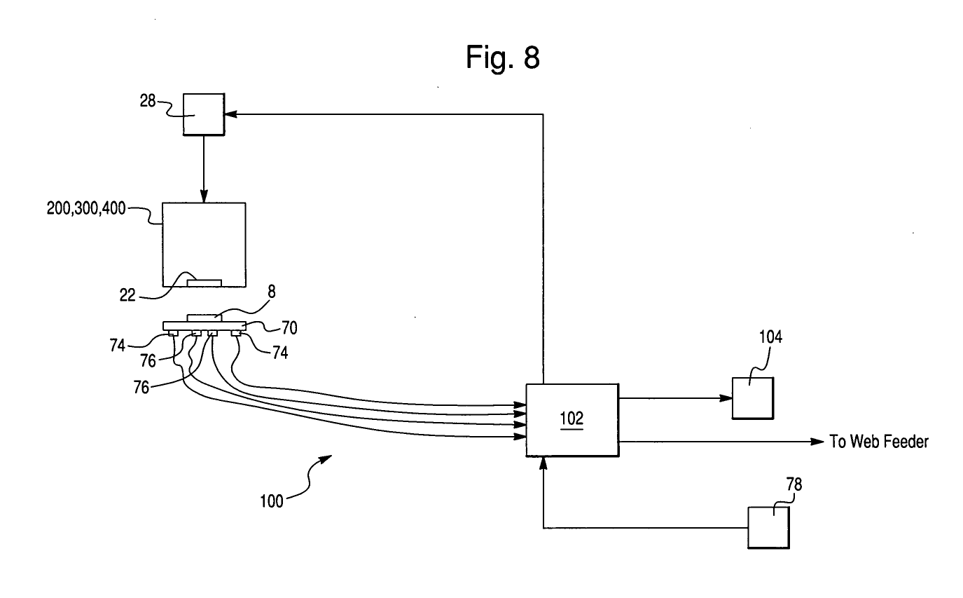

As shown in FIG. 8, the sensors 74 are electrically (wired) or wirelessly connected to a computer 102 to which the intensity signals are sent. Also electrically or wirelessly connected to the computer 102 are: (a) one or more temperature sensors 76 that monitor a temperature of the web 8 and that output signals reflective of such temperature; and (b) one or more speedometers 78 that measure the speed at which the web 8 is fed past the window 22, 422 and that output signals reflective of such speed. In the illustrated embodiment, the sensors 74 (light/energy), 76 (temperature), 78 (speed), and the computer 102 are all part of the control system 100.

In some embodiments, the temperature sensors 76 may, like the light/energy sensors 74, be provided on an outer surface of the transport device 70 or within the transport device 70 but stationary with respect to the curing housing 200, 300, 400 while the transport device 70 moves the web 8, as shown in FIG. 7. In other embodiments, the temperature sensors 76 may be provided at various locations along the length of the web 8. Assuming that the web 8 does not stretch or contract over its length, the speedometers 78 may be provided anywhere along the web, including at a position remote from the curing housing 200, 300, 400 such as, for example, adjacent a web feeder (not shown) that provides the web 8 to the transport device 70.

In some embodiments, such as when using a UV curing lamp housing 200, 300, the computer 102 is configured to calculate a dosage of light applied to the web 8 based on the light intensity measured by the radiometers 74 and the speed measured by the speedometers 78 (and possibly the temperature measured by the temperature sensors 76). Specifically, in some embodiments (e.g., for arc lamp light sources 26 such as externally triggered pulsed xenon light sources), the dosage is determined as follows. First, the width H (FIG. 7) of the window 22 is divided by the speed of the web 8 to obtain the duration that each portion of the web 8 is exposed to light emanating from the curing lamp housing 200, 300. Second, the duration is multiplied by the intensity of the light, as measured by the sensors 72, to obtain the light dosage.

By way of specific example, if width H of the web tunnel is 4.23 inches and the web speed is 300 feet per minute, the duration that each portion of the web 8 is exposed to light emanating from the curing lamp housing 200, 300 is determined as follows:

Speed=(300 ft/min)(1 min/60 s)(12 inches/ft)=60 inches/sec.

Duration=Width/Speed=(4.23 inches)/((60 inches)/s)=0.0705 s.

Further, if the intensity of the light is, for example, 4.96 W/cm , the light dosage may be calculated as follows:

$$\begin{matrix}Light Dosage = ( intensity ) ( duration ) \\ = ( 4.96 W \text{/} {cm}^{2} ) ( 0.0705 s ) \\ = 0.35 ( W ) ( s ) \text{/} {cm}^{2} \\ = 0.35 J \text{/} {cm}^{2} .\end{matrix}$$

As previously discussed, these calculations may be performed automatically by Electronic Instrumentation and Technology, Inc.'s PowerMAP sensor. Moreover, the results of these calculations may be transmitted by the PowerMAP sensor to the computer 102 such that the computer itself, in some embodiments, does not need to perform these calculations.

In other embodiments, such as when using an electron beam curing housing 400, the computer 102 may be configured to calculate a dosage of energy applied to the web 8 based on the energy intensity measured by the electron beam sensors 74 and the mass of the ink, varnish, adhesive, and/or adhesive with a lamination film 9 applied to the web. Specifically, in some electron beam embodiments, the energy dosage is determined by (a) multiplying the intensity of the electron beam (as measured by the sensors 74) by the time during which the ink, varnish, adhesive, and/or adhesive with a lamination film 9 is exposed to the electron beam to obtain a calculated energy per area (in J/cm²); (b) multiplying the calculated energy per area by the area (in cm²) of the ink, varnish, adhesive, and/or adhesive with a lamination film 9 exposed to the electron beam to obtain a calculated total energy (in J); (c) separately multiplying the volume (in cm³) of ink, varnish, adhesive, and/or adhesive with a lamination film 9 exposed to the electron beam by the density (in g/cm³) thereof to obtain a calculated mass (in g) of the ink, varnish, adhesive, and/or adhesive with a lamination film 9 exposed to the electron beam; and (d) dividing the calculate total energy by the calculated mass.

By way of specific example, if the intensity of the electron beam is 4.96 W/cm² (as above), the exposure time 0.0705 s (as above), the area of the ink, varnish, adhesive, and/or adhesive with a lamination film exposed to the electron beam is b 1 cm², the density of the ink, varnish, adhesive, and/or adhesive with a lamination film exposed to the electron beam is 6 g/cm³, and the volume of the ink, varnish, adhesive, and/or adhesive with a lamination film is 1 cm³, the energy dosage is calculated as follows:

$$\begin{matrix}Energy Dosage = ( ( intensity ) ( time ) ( area ) ) / ( ( density ) ( volume ) ) \\ = \text{(} ( 4.96 W \text{/} {cm}^{2} ) ( 0.0705 s ) ( 1.0 {cm}^{2} ) / ( ( 6 g \text{/} {cm}^{3} ) ( 1 {cm}^{3} ) ) \\ = 0.0583 ( W ) ( s ) \text{/} ( g ) \\ = 0.0583 J \text{/} g \\ = 0.0583 k J \text{/} k g \\ = 0.0583 k Gy .\end{matrix}$$

In other electron beam embodiments, the energy dosage (measured, e.g., in Mrads) may be calculated by multiplying an electron beam machine constant by the current (measured, e.g., in mA) applied thereto and divided by the speed of the web (measured, e.g., in feet per minute).

Regardless of the manner in which the calculated light or energy dosage is determined, the computer 102 compares the dosage with a predetermined value (or value range) in a look-up table. The predetermined values are based on the type and thickness of the ink, varnish, adhesive, and/or adhesive with a lamination film 9 applied to the web 8.

If the calculated light or energy dosage is outside a given predetermined range (i.e., above or below the limits of the range), at least two possible things can happen. First, the computer 102 can activate an alarm 104, thereby notifying a technician that the light or energy dosage for a given curing protocol is incorrect such that the technician may take appropriate corrective measures. Second, alternatively or additionally, the computer 102 can (via feedback control, which may be remote such as, e.g., via the internet): (a) instruct the web feeder (not shown) that directs the web 8 past the curing housing 200, 300, 400 to adjust the speed of the web 8, which may include stopping the web 8; and/or (b) instruct a power source 28 to adjust the intensity of the light being emitted by the light source 26 or energy being emitted by the electron source 426 (which may include cutting the power to the light source 26 or electron source 426). More specifically, the intensity of the light source 26 may be adjusted by adjusting the voltage input into a pulsed xenon arc lamp, thereby adjusting the spectral output of the xenon arc lamp). In contrast, if the calculated light dosage is within the predetermined range, the computer 102 maintains the speed of the web 8 and the intensity of the light emitted by the light source 26 or energy emitted by the electron source 426.

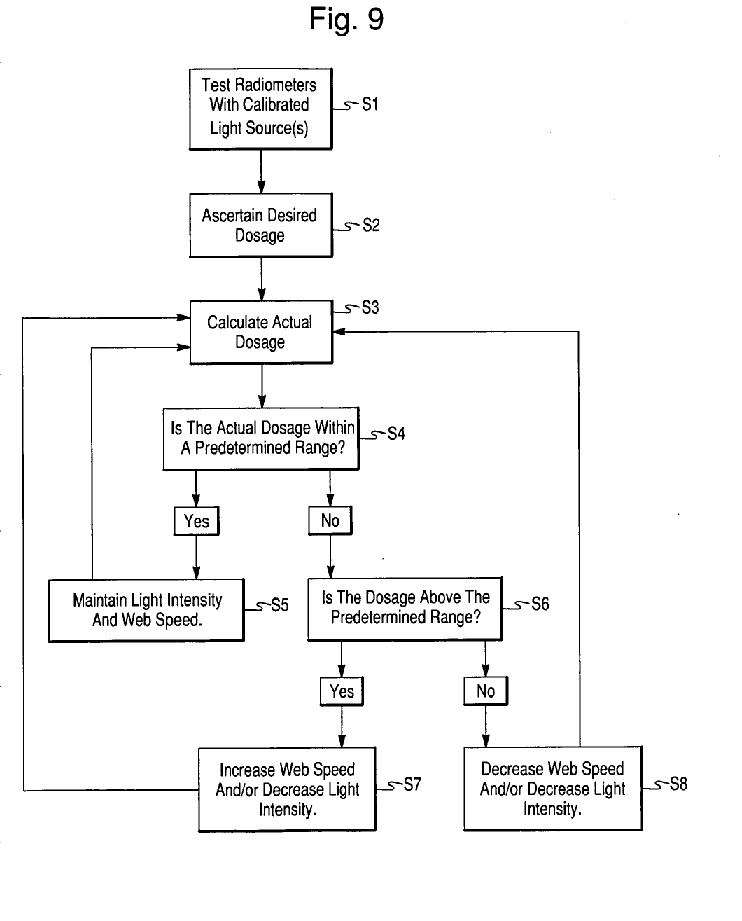

By way of example, a UV curing lamp control is shown in FIG. 9. Initially, in Step S1, the technician located at the curing housing tests the integrity (i.e., the intensity readings) of each of the sensors using one or more calibrated light sources. If any of the sensors 74 is malfunctioning, the technician either removes or replaces the malfunctioning sensor(s). If the malfunctioning sensor(s) is/are replaced, the technician then tests the integrity of the replacement sensor(s) using the calibrated light source. Once the integrity of each of the sensors 74 is configured, the technician ascertains, in Step S2, a desired predetermined dosage or dosage range either by: (a) scanning dosage information stored (e.g., on a 1-dimensional or 2-dimensional barcode or on an active or passive radio frequency identification (“RFID”) chip such as that disclosed in U.S. Patent No. 5,811,784) on an item associated with the web that it to be cured; or (b) electronically receiving the dosage information from a remote location (e.g., via an internet connection). Subsequently, in Step S3 the technician calculates the actual dosage of the light or energy emitted by the curing housing by using the intensity of the light and the speed of the web. Then, in Step S4, the technician determines whether the actual light dosage is within a predetermined range. If so, control proceeds to Step S5 in which the technician maintains the speed of the web 8 and the intensity of the light emitted by the light source 26. If not, control proceeds to Step S6 in which the technician determines if the light dosage is above the predetermined range. If so, control proceeds to Step S7 in which the technician can instruct: (a) the web feeder to increase the speed of the web 8; and/or (b) the power source 28 to decrease (or discontinue) the intensity of the light (e.g., by decreasing or eliminating the voltage applied to a pulsed xenon light source to adjust the spectral output thereof). If not, control proceeds to Step S8 in which the technician can instruct: (a) the web feeder to decrease the speed of the web 8; and/or (b) the power source 28 to increase (or discontinue) the intensity of the light (e.g., by increasing or eliminating the voltage applied to a pulsed xenon light source to adjust the spectral output thereof). Regardless of the outcome, control returns from Steps S5, S7, and S8 to Step S3. Subsequent iterations of the method steps S3-S8 may be remotely performed by the computer 102, which may be electrically connected to the curing housing such as, e.g., by way of an internet connection, thereby ensuring continuous monitoring and controlling of the curing process. As a similar protocol is used to monitor and, if necessary, adjust the intensity of energy emanating from an electron beam curing housing 400, a duplicative discussion thereof is omitted. Moreover, the importance of using such a control system 100 to control an energy dosage of an electron beam curing housing 400 cannot be understated as electrons have mass and, therefore, can do work.

In addition to the aforementioned light intensity control, the control system 100 can also be used to protect the integrity of the web 8. Specifically, the temperature sensors 76 may be used to monitor a temperature of the web 8 such that if the monitored temperature exceeds a predetermined temperature limit, the computer 102 can take protective measures. The predetermined upper temperature limit may be an indicator of web failure. Such a situation may happen, for example, in instances in which an inefficient light source is operated at full power to produce a low intensity light; the correspondingly slow speed at which the web 8 must be moved in response to such low intensity (to obtain the proper light dosage) may be such that the radiant heat from the light source overheats the web.

When notified by the temperature sensors 76 of an overheating situation, the computer 102 may initiate a number of protective measures. First, as a passive control, the computer 102 could activate the alarm 104, thereby notifying a technician of the problem. Second, as an active control, the computer 102 could instruct: (a) the shutters 12 to be closed; (b) the web feeder to increase the speed of the web; and/or (c) the power source 28 to decrease (or discontinue) the power to the light or energy source. Of course, both the passive and one or more of the active controls could be collectively employed to protect the web.

For both light and energy applications, the computer 102 can also be used for extrapolation and table creation purposes. Specifically, the computer 102 can use (a) the fixed width H of the opening 22, 422 and (b) a given web speed to extrapolate dosage values based on that given web speed and any intensity value. Similarly, the computer 102 can use (a) the fixed width H of the opening 22, 422 and (b) a given intensity value to extrapolate dosage values based on that given intensity and any web speed.

By way of a first specific example, if the web speed is constant, the duration of exposure is also constant (i.e., the duration is readily calculated as the width H divided by the constant speed). By multiplying the fixed duration by any intensity, the dosage can be readily determined for that intensity based on the constant web speed. Accordingly, if the web speed were, as before, fixed at 300 feet per minute (such that the duration was 0.0705 seconds) and the sensor measured a first intensity to be 6.12 W/cm² and a second intensity to be 5.56 W/cm², the dosages would be calculated as follows:

Dosage=(duration)(intensity)

First Dosage=(0.0705 s)(6.12 W/cm²)=0.43 J/cm² and the

Second Dosage=(0.0705 s)(5.56 W/cm²)=0.39 J/cm².

### Accordingly, for a given web speed (e.g., 300 feet per minute), the dosage can be extrapolated for any intensity value.

Similarly, and by way of a second specific example, if the width H is divided by any web speed, a duration is readily calculable for that web speed. By multiplying that duration by a constant intensity, the dosage can be readily determined for that web speed based on the constant intensity. Accordingly, if the sensor 74 measured a constant (normalized) intensity of 4.96 W/cm², the dosage applied to the web at a first speed of 275 feet per minute and at a second speed of 325 feet per minute would be extrapolated as follows:

Duration=width/rate

First Duration=(4.23 inches)/(275 feet/min)×(1 ft/12 inches)×(60 s/1 min)=0.0769 s

Second Duration=(4.23 inches)/(325 feet/min)×(1 ft/12 inches)×(60 s/1 min)=0.0651 s

Dosage=(duration)(intensity)

First Dosage=(0.0769 s)(4.96 W/cm²)=0.38 J/cm²

Second Dosage=(0.0651 s)(4.96 W/cm²)=0.32 J/cm².

### Accordingly, for a given intensity (e.g., 4.96 W/cm²), the dosage can be extrapolated for any web speed.

As a result of the foregoing, a table may be created for each combination of web speeds and intensities. Moreover, for any given combination, the temperature of the web 8 can be recorded. As a result, a technician may chose a particular web speed and intensity combination that: (a) would properly cure an ink, varnish, adhesive, and/or adhesive with a lamination film 9 on the web 8; (b) would not overheat the web; and/or (c) would be as efficient (in terms of time and energy consumption) as desirable and/or possible.

Although the aforementioned describes embodiments of the invention, the invention is not so restricted. It will be apparent to those skilled in the art that various modifications and variations can be made to the disclosed preferred embodiments of the present invention without departing from the scope or spirit of the invention. For example, rather than activate the alarm 104 when the light dosage, energy dosage, or web temperature is outside a predetermined dosage range, the control system 100 could activate the alarm 104 when the light dosage, energy dosage, or web temperature, although acceptable, is near a limit of the predetermined dosage range. In addition, after each press run, the computer 102 can output (e.g., by printing) the light or energy dosage that was applied during the run and/or the temperature of the web.

In light of the foregoing, it should be understood that the apparatus and method described herein are illustrative only and are not limiting upon the scope of the invention, which is indicated by the following claims.

What is claimed is:

1. A curing device for curing an ink, varnish, adhesive, and/or adhesive with a lamination film on a web, the curing device comprising:
a curing housing comprising:
a xenon lamp that is configured to emit light; and
an outlet for light emitted by the xenon lamp; and
a control system configured to:
calculate a dosage of light applied to an ink, varnish, adhesive, and/or adhesive with a lamination film on a web; and
adjust or maintain the dosage of light applied to the ink, varnish, adhesive, and/or adhesive with a lamination film on the web based on the calculated dosage of light.

2. The curing device according to claim 1, wherein the xenon lamp is configured to emit light in response to a pulsed voltage applied to the xenon lamp.

3. The curing device according to claim 2, wherein the control system is configured to adjust the dosage of light by adjusting the duration and/or magnitude of the pulsed voltage applied to the xenon lamp.

4. The curing device according to claim 1, wherein the control system is further configured to:
determine a speed of the web passing the outlet; and
determine an intensity of the light passing through the outlet.

5. The curing device according to claim 4, wherein the control system is configured to calculate the dosage of light based on the speed of the web and the intensity of the light.

6. The curing device according to claim 4, wherein the control system is configured to adjust the dosage of light by adjusting the intensity of the light and/or the speed of the web.

7. The curing device according to claim 1, wherein the control system comprises at least one radiometer that is configured to measure the intensity of the light.

8. The curing device according to claim 1, wherein the control system comprises at least one speedometer that is configured to measure the speed of the web passing the outlet.

9. The curing device according to claim 1, wherein the control system comprises at least one temperature sensor.

10. The curing device according to claim 9,
wherein the at least one temperature sensor is configured to measure a temperature of the web, and
wherein, if the temperature of the web exceeds a predetermined value, the control system is configured do at least one of the following: (i) activate an alarm; (ii) increase the speed of the web; (iii) decrease the intensity of the light emitted by the housing; (iv) prevent the light from exiting the housing; and/or (v) deactivate the curing housing.

11. The curing device according to claim 1, wherein the curing housing further comprises a filter configured to reflect or transmit light that has wavelength(s) that fall within a predetermined wavelength range toward the outlet

12. The curing device according to claim 10, wherein the filter is configured to let UV light pass therethrough.

13. The curing device according to claim 1, further comprising:
an alarm that is configured to alert a technician if the calculated dosage of light differs from a predetermined dosage or is outside a predetermined dosage range.

14. The curing device according to claim 1, wherein the predetermined dosage and predetermined dosage range are based on the type and thickness of the ink, varnish, adhesive, and/or adhesive with a lamination film applied to the web.

15. The curing device according to claim 1, further comprising:
a heat sink,
wherein the web is positioned between the curing housing outlet and the heat sink.

16. A curing device for curing an ink, varnish, adhesive, and/or adhesive with a lamination film on a web, the curing device comprising:
a curing housing comprising:
a xenon lamp that is configured to emit light; and
an outlet for light emitted by the light source;
means for calculating a dosage of light applied to an ink, varnish, adhesive, and/or adhesive with a lamination film on a web via the outlet; and
means for adjusting or maintaining the dosage of light applied to the ink, varnish, adhesive, and/or adhesive with a lamination film on the web based on the calculated dosage of light.

17. The curing device according to claim 16, wherein the xenon lamp is configured to emit light in response to a pulsed voltage applied to the xenon lamp.

18. The curing device according to claim 17, wherein the means for adjusting or maintaining the dosage of light is configured to adjust the dosage of light by adjusting the duration and/or magnitude of the pulsed voltage applied to the xenon lamp.

19. The curing device according to claim 16, further comprising:
means for determining a speed of the web passing the outlet; and
means for determining an intensity of the light passing through the outlet.

20. The curing device according to claim 19, wherein the means for calculating a dosage of light applied to the web is configured to calculate the dosage of light based on the speed of the web and the intensity of the light.

21. The curing device according to claim 19, wherein the means for determining the speed of a web passing the outlet comprises at least one speedometer.

22. The curing device according to claim 16, wherein the means for adjusting the dosage of light is configured to adjust the dosage of light by adjusting the intensity of the light and/or the speed of the web.

23. The curing device according to claim 16, further comprising:
at least one temperature sensor configured to measure a temperature of the web; and
control means,
wherein, if the temperature of the web exceeds a predetermined value, the control means is configured to do at least one of the following: (i) activate an alarm; (ii) increase the speed of the web; (iii) decrease the intensity of the light emitted by the housing; (iv) prevent the light from exiting the housing; and/or (v) deactivate the curing housing.

24. The curing device according to claim 19, wherein the means for determining an intensity of the light passing through the outlet comprises at least one radiometer.

25. The curing device according to claim 24, wherein at least one of the radiometers is aligned with the outlet at a position in which the web is not configured to pass between the radiometer and the lamp.

26. The curing device according to claim 16, further comprising:
a temperature sensor configured to monitor a temperature of the web passing the outlet.

27. The curing device according to claim 16, wherein the curing housing further comprises a filter configured to reflect or transmit light that has wavelength(s) that fall within a predetermined wavelength range toward the outlet

28. The curing device according to claim 27, wherein the filter is configured to enable UV light to pass therethrough.

29. The curing device according to claim 16, further comprising:
an alarm that is configured to alert a technician if the calculated dosage of light differs from a predetermined dosage or is outside a predetermined dosage range.

30. The curing device according to claim 29, wherein the predetermined dosage and predetermined dosage range are based on the type and thickness of the ink, varnish, adhesive, and/or adhesive with a lamination film applied to the web.

31. The curing device according to claim 16, further comprising:
a heat sink,
wherein the web is positioned between the curing housing outlet and the heat sink.

32. A method comprising the steps of:
(A) emitting light using a curing housing;
(B) determining a dosage of the light emitted by the curing housing;
(C) comparing the determined dosage of light to a predetermined dosage or predetermined dosage range; and
(D) performing one of the following steps (i) and (ii):
(i) if the determined dosage of light is compared in step (C) to a predetermined dosage, performing one of the following steps (a) and (b):
(a) adjusting an intensity of the light emitted by the curing housing and/or a speed of a web on which an ink, varnish, adhesive, and/or adhesive with a lamination film will be provided if the determined dosage of light differs from the predetermined dosage; or
(b) maintaining the speed of the web and the intensity of the light emitted by the curing housing, if the determined dosage of light is substantially the same as the predetermined dosage; or
(ii) if the determined dosage of light is compared in step (C) to a predetermined dosage range, performing one of the following steps (c) and (d):
(c) adjusting the intensity of the light emitted by the curing housing and/or the speed of the web if the determined dosage of light is outside the predetermined dosage range; or
(d) maintaining the speed of the web and the intensity of the light emitted by the curing housing, if the determined dosage of light is within the predetermined dosage range.

33. The method according to claim 32, further comprising the step of:
(E) cyclically repeating steps (B)-(D).

34. The method according to claim 33, wherein steps (B), (C), and (D) are initially performed by a technician located at the curing housing.

35. The method according to claim 34, wherein steps (B), (C), and (D) are subsequently performed by a controller that is electrically connected to the curing housing.

36. The method according to claim 35, wherein the controller is electrically connected to the curing housing via an internet connection.

37. The method according to claim 32, further comprising the steps of:
determining an intensity of the light emitted by the curing housing using one or more radiometers; and
determining the speed at which the web is moving relative to the curing housing.

38. The method according to claim 37, wherein the step of (B) determining a dosage of the light emitted by the curing housing uses the determined intensity of the light emitted by the curing housing and the determined speed at which the web is moving.

39. The method according to claim 32, wherein before the step of (A) emitting light using a curing housing, the method further comprises the steps of:
(A1) emitting light using a calibrated light source; and
(A2) determining an intensity of the light emitted by the calibrated light source using one or more radiometers.

40. The method according to claim 39 further comprising the steps of:
(A3) ascertaining whether any of the radiometers is malfunctioning by comparing the intensity of the light emitted by the calibrated light source as determined by each of the radiometers to a predetermined, calibrated light intensity or to a predetermined, calibrated light intensity range;
(A4) if any of the radiometers is ascertained to be malfunctioning, either:
(i) removing the malfunctioning radiometer(s); or
(ii) replacing the malfunctioning radiometer(s) and repeating steps (A2) and (A3); and
(A5) eliminating the light emitted by the calibrated light source.

41. The method according to claim 39, wherein the step of (A)(1) emitting light using a calibrated light source, comprises the step of:
positioning the calibrated light source in a predetermined location relative to the curing housing and/or the one or more radiometers.

42. The method according to claim 32, wherein the steps of (D)(i)(a) and/or (D)(ii)(c) adjusting the intensity of the light emitted by the curing housing, comprises the step of:
eliminating the light emitted by the curing housing.

43. The method according to claim 32, wherein the steps of (D)(i)(a) and/or (D)(ii)(c) adjusting the speed of the web, comprises the step of:
stopping the web.

44. The method according to claim 32, wherein before the step of (A) emitting light using a curing housing, the method further comprises the step of:
ascertaining the predetermined dosage or predetermined dosage range.

45. The method according to claim 44, wherein the step of ascertaining the predetermined dosage or predetermined dosage range comprises one or more of the following steps:
scanning a barcode and obtaining from a lookup table dosage information corresponding to the barcode;
reading information stored on a radio frequency identification chip; and/or
receiving dosage information from a remote location.
